(19) United States
(12) Patent Application Publication
(10) Pub. No.: US 2008/0273184 A1
(43) Pub. Date: Nov. 6, 2008

(54) APPARATUS AND METHOD FOR REFERENTIAL POSITION MEASUREMENT AND PATTERN-FORMING APPARATUS

(75) Inventors: Yasuhiko MORIMOTO, Kanagawa (JP); Hiroshi UEMURA, Kanagawa (JP); Takashi FUKUI, Kanagawa (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/052,798

(22) Filed: Mar. 21, 2008

(30) Foreign Application Priority Data
Mar. 30, 2007 (JP) 2007-090722

(51) Int. Cl. G03B 27/68

(52) U.S. Cl. 355/52

(57) ABSTRACT

A digital exposure apparatus for forming a pattern on a topside surface of a substrate has an alignment unit, which detects a position of the substrate from image data obtained through a camera from a reference mark provided on the topside surface of the substrate. The alignment unit further has a Z-direction sensor to measure a fluctuation amount Δ of the topside surface of the substrate from a predetermined focal plane of the camera. Depending upon the measured amount Δ, a set of distortion correction data is selected from or calculated on the basis of previously stored distortion correction data. The image data of the reference mark is corrected with the selected or calculated distortion correction data, so that errors induced by the fluctuation from the focal plane are corrected without adjusting the position of the substrate in the direction of an optical axis of the camera of the alignment unit.

### FIELD OF THE INVENTION

The present invention relates to an apparatus and a method of measuring referential position of a substrate by way of reference marks provided on the substrate. The present invention relates also to a pattern-forming apparatus for forming a pattern on a substrate, the pattern-forming apparatus being provided with the referential position measuring apparatus to adjust pattern-forming position on the substrate on the basis of position data measured by the referential position measuring apparatus.

### BACKGROUND OF THE INVENTION

A digital exposure apparatus, or called a multi-beam exposure apparatus or a beam lithography, is known as a pattern-forming apparatus for forming a pattern on a substrate. The digital exposure apparatus is provided with a spatial light modulator like a digital micromirror device (DMD) in its pattern-forming section, and drives the DMD based on pattern data (digital image signal of a pattern) to modulate light beams so as to form the pattern on a substrate by exposing the substrate to the modulated light beams. The DMD is a mirror device that is constituted of an array of micro mirrors mounted on an array of semiconductor random access memory cells (SRAM cells) in one-to-one relationship. The micro mirrors as well as the SRAM cells are arranged in a two-dimensional matrix, and the micro mirrors switch over their respective reflection surfaces between two tilt directions individually in accordance with binary values of the pattern data (electro statistic charges) written in the corresponding SRAM cells.

The digital exposure apparatus is provided with a referential position measuring apparatus, or called an alignment unit, for measuring positions of reference marks provided on the substrate. The referential position measuring apparatus measures the positions of the reference marks by taking images of the reference marks through cameras while the substrate on a movable stage is being carried in a direction at a constant speed. On the basis of the measured referential positions, the exposure apparatus adjusts the pattern-forming position on the substrate on the substrate, as disclosed for example in WO2007-890 (JPA2007-10736).

Since very slight physical deformations exit in optical systems or an imaging device, which are used in the camera of the referential position measuring apparatus, the image taken by the camera has a correspondingly slight distortion. Even a very slight distortion is not ignorable as the positions of the reference marks need to be measured with high accuracy and precision. To solve this problem, the above-mentioned prior art suggests correcting the taken image data with prepared distortion correction data so as to offset against the distortion and thus boost the accuracy of position-measurement of the reference marks.

Besides, the taken image can suffer a distortion from a variation in image-magnification of the image, which is induced by a fluctuation in position of a topside surface of the substrate in a direction of an optical axis of the camera, i.e. in a direction perpendicular to the topside surface of the substrate. The fluctuation in position of the topside surface of the substrate results from difference between individual substrates, difference in accuracy of the stage in holding the substrate or the like. In order to suppress the influence of the fluctuation in the topside surface position, the camera of the referential position measuring apparatus uses a telecentric optical system that scarcely varies the image-magnification with a change in subject distance, i.e. the change in position of the subject in the optical axis direction, so it has a long depth of field and thus allows a wide measurable range to the subject. But even in the telecentric optics, a little error, so-called telecentric error, is induced by a variation in position of the subject in the optical axis direction. The telecentric error cannot be ignored in the referential position measuring apparatus that is required to have a very high accuracy. To solve this problem, it is possible to adjust the image-magnification by changing the height of the stage and thus the position of the substrate in the optical axis direction of the camera, in the way as disclosed in JPA2006-332480 or JPA1999-295230.

However, there is a problem in applying the height adjustment of the stage, as disclosed in the latter prior arts, to the digital exposure apparatus of the former prior art, that the height adjustment of the stage needs an intermission of the movement of the stage during the measuring process of the reference mark positions, which elongates the total time for the referential position measurement of the substrate and thus lowers the efficiency (throughput) of processing the substrate.

### SUMMARY OF THE INVENTION

In view of the foregoing, a primary object of the present invention is to provide a referential position measuring apparatus for measuring position of at least a reference mark that is formed on a stage or on a topside surface of a substrate placed on the stage and a referential position measuring method for the apparatus, which correct such errors in position detection of the reference mark that are induced by height fluctuation of the substrate, without lowering the throughput of the substrate. The present invention also has an object to provide a pattern-forming apparatus that is provided with the referential position measuring apparatus of the present invention, to adjust a pattern-forming position on the substrate on the basis of position data of the reference mark measured by the referential position measuring apparatus.

To achieve the above and other objects, a referential position measuring apparatus of the present invention comprises an imaging device located above the stage, for taking an image of the reference mark in a direction substantially perpendicular to the topside surface of the substrate; a storage device storing different sets of distortion correction data corresponding to different levels of fluctuation of the topside surface of the substrate from a predetermined focal plane of the imaging device; a measuring device for measuring a fluctuation amount of the topside surface of the substrate from the predetermined focal plane of the imaging device; a deciding device for deciding an optimum set of distortion correction data on the basis of the measured fluctuation amount and the distortion correction data stored in the storage device; a correction device for correcting distortion of the image of the reference mark as taken by the imaging device with the distortion correction data as decided by the deciding device; and a position determining device for determining the position of the reference mark on the basis of the image of the reference mark after the distortion is corrected by the correction device.

Preferably, the distortion correction data is directed to correct a distortion of the image induced by physical deformation of the imaging device and a change in image-magnification induced by the fluctuation of the topside surface of the substrate from the predetermined focal plane of the imaging device.

Preferably, the distortion correction data consists of two-dimensional correction vectors allocated to all pixels of the image taken by the imaging device. The imaging device preferably comprises a telecentric optical system.

A pattern-forming apparatus of the present invention comprises a pattern-forming device driven in accordance with pattern data to form a pattern on a topside surface of a substrate as placed on a stage; a transfer device for moving the stage or the pattern-forming device so that the substrate relatively moves past a pattern-forming field of the pattern-forming device; a referential position measuring device for measuring position of at least a reference mark that is formed on the stage or on the topside surface of the substrate; and an adjusting device for adjusting pattern-forming position of the pattern-forming device relative to the topside surface of the substrate on the basis of the position of the reference mark as measured by the referential position measuring device, wherein the referential position measuring device is configured as the above recited referential position measuring apparatus of the present invention.

Preferably, the adjusting device adjusts the pattern-forming position by correcting the pattern data with reference to the position of the reference mark as measured by the referential position measuring device.

Preferably, the transfer device moves the stage along a linear track, whereas the referential position measuring device and the pattern-forming device are fixedly disposed above the linear track.

Preferably, the topside surface of the substrate is provided with a photosensitive material, and the pattern-forming device forms the pattern by exposing the topside surface to light beams. More preferably, the pattern-forming device comprises a digital micromirror device that modulates the light beams in accordance with the pattern data, whereas the pattern-forming device comprises an array of exposure heads, each of which is provided with the digital micromirror device, the exposure heads being arranged in rows orthogonally to a direction of the relative movement of the substrate to the pattern-forming device.

A referential position measuring method of the present invention comprises the following steps:

storing different sets of distortion correction data corresponding to different levels of fluctuation of the topside surface of the substrate from a predetermined focal plane of an imaging device whose optical axis is substantially perpendicular to the topside surface of the substrate;

taking an image of the reference mark through the imaging device;

measuring a fluctuation amount of the topside surface of the substrate from the predetermined focal plane;

deciding an optimum set of distortion correction data on the basis of the measured fluctuation amount and the stored distortion correction data;

correcting distortion of the image of the reference mark with the decided distortion correction data; and

determining the position of the reference mark on the basis of the image after the distortion is corrected.

The referential position measuring apparatus and the referential position measuring method of the present invention previously stores different sets of distortion correction data with respect to different levels of positional fluctuation of the topside surface of the substrate from the predetermined focal plane of the imaging device, and measures the position of the topside surface during the imaging of the reference mark, to determine an optimum set of distortion correction data on the basis of the stored sets of distortion correction data. And the distortion of the image taken from the reference mark is corrected with the determined distortion correction data. Therefore, even while the topside surface of the substrate fluctuates from the predetermined focal plane to cause an error in the detection result about the position of the reference mark, the error is corrected without the need for adjusting the position of the stage in the axial direction of the imaging device, i.e. the perpendicular direction to the topside surface of the substrate.

Consequently, the pattern-forming apparatus of the present invention, which is provided with the referential position measuring apparatus of the present invention, does not need to stop the stage to adjust its vertical position or height. Therefore, the pattern-forming apparatus of the present invention achieves high throughput efficiencies.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic perspective view of a digital exposure apparatus;

FIG. 2 is a schematic side view of a movable stage;

FIG. 3 is a pattern view illustrating an internal structure of an exposure head of the digital exposure apparatus;

FIG. 4 is a schematic perspective view of a digital mirror device of the digital exposure apparatus;

FIG. 5 is a schematic perspective view illustrating exposure areas on a substrate, which are exposed by the exposure heads;

FIG. 6 is a block diagram illustrating an alignment unit of the digital exposure apparatus;

FIG. 7 is a schematic plan view illustrating correction vectors that constitute distortion correction data;

FIG. 8 is an explanatory diagram illustrating an example of relation between a positional of a reference mark after distortion correction and an ideal position of the reference mark;

FIG. 9 is a block diagram illustrating an electric structure of the digital exposure apparatus;

FIGS. 10A, 10B and 10B are explanatory diagrams illustrating an operation sequence of the digital exposure apparatus;

FIG. 11 is a block diagram illustrating a distortion correction data producer;

FIG. 12 is a schematic plan view illustrating a calibration pattern formed on a substrate for calibration;

FIG. 13 is an explanatory diagram illustrating an image taken from the calibration pattern; and

FIG. 14 is a flowchart illustrating an operation sequence of a distortion correction data production mode.

### DESCRIPTION OF THE PREFERRED EMBODIMENTS

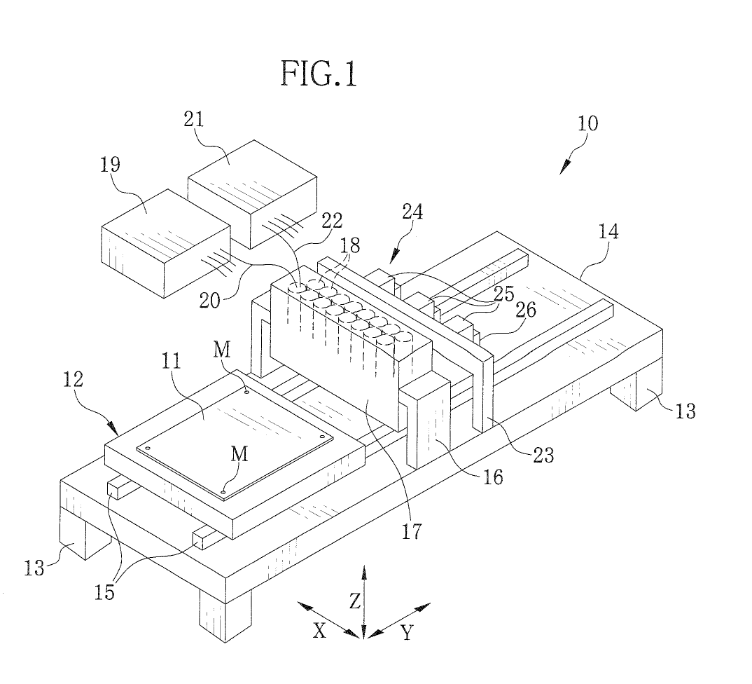

In FIG. 1, a digital exposure apparatus 10 is provided with a planer stage 12 for carrying a substrate 11 thereon as a target object to form a pattern thereon by optical lithography. The planer stage 12 holds the substrate 11 on its topside by suction. The substrate 11 is one for forming a printed circuit board or a glass substrate for a flat panel display, and a photosensitive material is provided on its topside by coating or adhesion. Also reference marks M are provided on the topside or photosensitive surface of the substrate 11, showing referential points for aligning an exposure position or pattern-forming position on the substrate 11. For example, the reference marks M are formed by embossing thin film and located at each corner of the rectangular substrate 11.

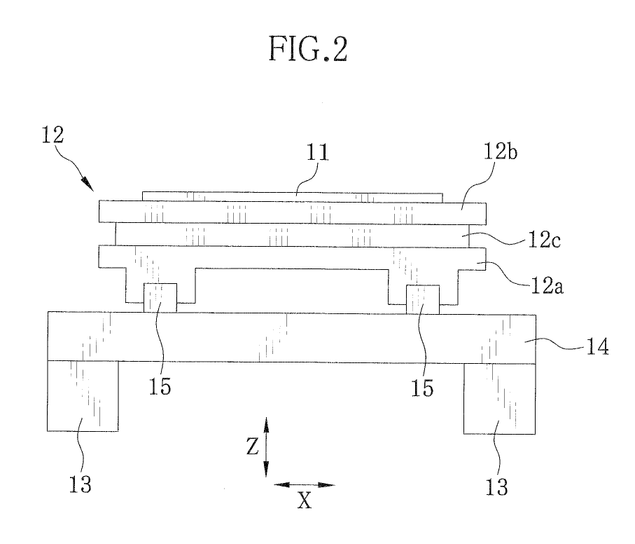

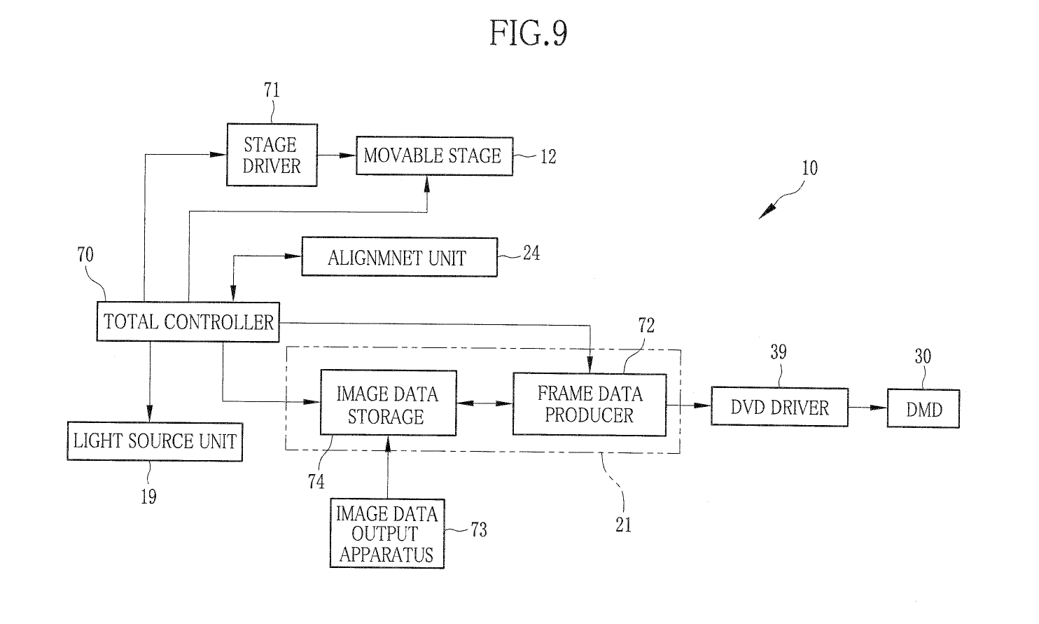

A base table 14 supports itself on four legs 13, and has a couple of parallel guide rails 15 on its top side. The guide rails 15 extend along a lengthwise direction of the table 14, hereinafter called the Y direction, to provide a linear track. As shown in FIG. 2, a leg portion 12a of the movable stage 12 is so mounted on the guide rails 15 that the movable stage 12 can slide on the guide rails 15 in the Y direction as the movable stage 12 is driven by a stage driver 71 (see FIG. 9), which is constituted of a linear motor. The movable stage 12 is also provided with a substrate holder 12b for holding the substrate 11 by suction, and an up-down mechanism 12c for moving the substrate holder 12b up and down, i.e. in the vertical direction (Z direction).

A gate 16 is fixedly mounted in a middle zone of the table 14 with respect to the Y direction, to extend over the guide rails 15. The gate 16 is provided with an exposure unit 17 that consists of an array of exposure heads 18. For example, sixteen exposure heads 18 are arranged in two rows across the linear track of the movable stage 12. Thus, the exposure unit 17 is fixedly disposed over the track of the movable stage 12. That is, the exposure heads 18 are aligned in an orthogonal direction to the Y direction, hereinafter called the X direction.

The exposure unit 17 is connected to a light source unit 19 through optical fibers 20, and to an image processing unit 21 through signal cables 22. The exposure heads 18 modulate light beams from the light source unit 19 on the basis of frame data (pattern data) fed from the image processing unit 21, and expose the substrate 11 to the modulated light beams to draw an image photo-lithographically on the substrate 11. Note that the number or arrangement of the exposure heads 18 may vary depending upon the size of the substrate 11 or other factors.

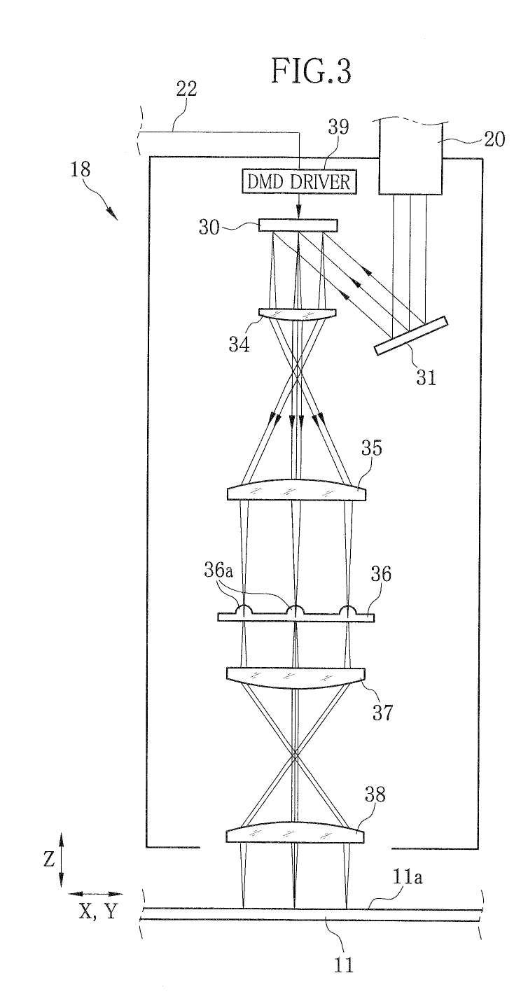

Besides the gate 16, a gate 23 extends over the guide rails 15 on the table 14, and an alignment unit 24 is mounted to the gate 23. The alignment unit 24 is provided with three cameras 25, each of which takes an image of the topside surface 11a (see FIG. 3) of the substrate 11, viewing vertically from above it, that is, in a substantially perpendicular direction to the topside surface 11a. Z-direction sensors 26 are fixedly mounted to the respective cameras 25. For example, the Z-direction sensors 26 are laser displacement meters for measuring the vertical position or height of the topside surface 11aof the substrate 11.

As will be described in detail later, the alignment unit 24 measures positions of the respective reference marks M on the basis of images obtained by the respective cameras 25, and detects data about the position of the substrate 11 on the movable stage 12, to determine a deviation amount of the substrate 11 from an ideal or designed position. The detected position data or deviation amount is used for adjusting the exposure position on the substrate 11, where the topside surface 11ais exposed by the exposure unit 17. Note that the number of the cameras 25 may vary depending upon the size of the substrate 11 or other factors. The Z-direction sensors 26 or the laser displacement meters preferably use laser beams of such a wavelength range that the photosensitive material on the topside surface 11aof the substrate 11 is not sensitive to.

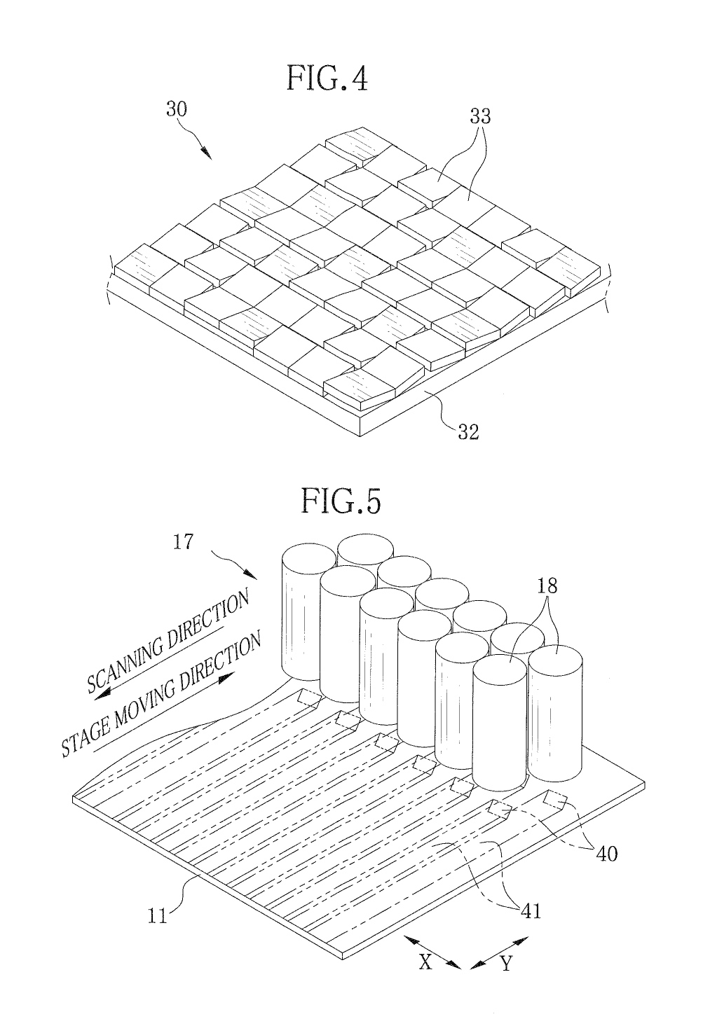

FIG. 3 shows an internal structure of the individual exposure head 18. The exposure head 18 is provided with a digital micromirror device (DMD) 30 as a spatial light modulator, and a reflection mirror 31 for reflecting the laser beams from the optical fibers 20 toward an incident surface of the DMD 30. As shown in FIG. 4, the DMD 30 consists of multiple of micromirrors 33 arranged in one-to-one relationship on respective cells of an SRAM cell array 32. Each micromirror 30 is supported on a not-shown pivot so that it can sway on the pivot between two tilt positions. For example, the micromirrors 33 are arranged in a 600×800 matrix grid, so the DMD 30 is rectangle as the whole. A DMD driver 39 is connected to the signal cables 22, through which the frame data is fed from the image processing unit 21 to the DMD driver 39, and the DMD driver 39 writes the frame data in the respective cells of the SRAM array 32.

Each cell of the SRAM array 32 is constituted of a flip-flop circuit, which switches over its electrostatic condition according to a binary value (1 or 0) of the frame data written in the cell. The micromirror 33 individually changes its tilt position according to the electrostatic condition of the corresponding SRAM cell, thereby changing the reflecting direction of the laser beams from the reflection mirror 31. That is, the DMD 30 reflects the incident laser beams while modifying them according to the frame data. For example, merely those micromirrors 33 which correspond to those SRAM cells having the data value “0” written therein reflect the laser beams toward a lens system 34, whereas the laser beams reflected from other micromirrors 33, i.e. ones corresponding to those SRAM cells having the data value “1”, are absorbed into a not-shown light absorbing member, and thus not served for exposure.

The lens system 34 and a lens system 35 constitute a magnifying optical system that spreads the flux of the reflected light beams to a certain size, so that an enlarged image of the reflected light beams is formed on a micro lens array 36, which is placed on the output side of the lens system 35. The micro lens array 36 is formed by integrating multiple of micro lenses 36a into one body, which are arranged in one-to-one relationship to the respective micromirrors 33 of the DMD 30. That is, the micro lenses 36a are on optical axes of the respective laser beams from the lens systems 34 and 35. The micro lens array 36 sharpens the incident enlarged image and lets the sharpened image incident on a lens system 37. In the present embodiment, the lens system 37 and a lens system 38 constitute a fixed magnification optical system, and project the optical image onto the substrate 11 in the same size as it is incident on the lens system 37. Thus, the substrate 11 is exposed to the optical image. Each of the exposure heads 18 is so positioned that a rear focal plane of the optical system 37 and 38 coincides with the topside surface 11aof the substrate 11 as carried on the movable stage 12.

As shown in FIG. 5, each exposure area 40 on the substrate 11, the area exposed at a time by the individual exposure head 18, has a similar shape to that of the DMD 30, i.e., rectangle. The DMD 30 is so arranged that its four sides slightly tilt, for example 0.1 to 0.5 degrees, relative to the Y direction, i.e. the moving direction of the stage 12. Correspondingly, the exposure area 40 tilts relative to the direction of moving the stage 12, that is a scanning direction of the exposure unit 17 across the substrate 11, in the relative movement between the stage 12 and the exposure unit 17. As a result, exposure points or pixels, which correspond to the respective micro mirrors 33 of the DMD 30, are arranged in a grid that slightly tilts relative to the scanning direction, so that pitches between scanning lines or intervals in the X direction of the exposure points are narrowed in comparison with a case where the DMD 30 does not tilt relative to the scanning direction. The narrower pitches between the scanning lines raise the pixel density and thus achieve the higher resolution of the subsequent image.

The exposure heads 18 are arranged tightly in two rows along the X direction that is substantially perpendicular to the moving direction of the stage 12, i.e. the scanning direction. The exposure heads 18 in the first row are staggered from ones in the second row by a half pitch. Thereby, the exposure heads 18 of the second row expose such zones of the substrate 11 that cannot be exposed by the exposure heads 18 of the first row. Consequently, with the movement of the stage 12, exposed belt zones 41 are formed on the substrate 11 along the scanning direction tightly in the X direction.

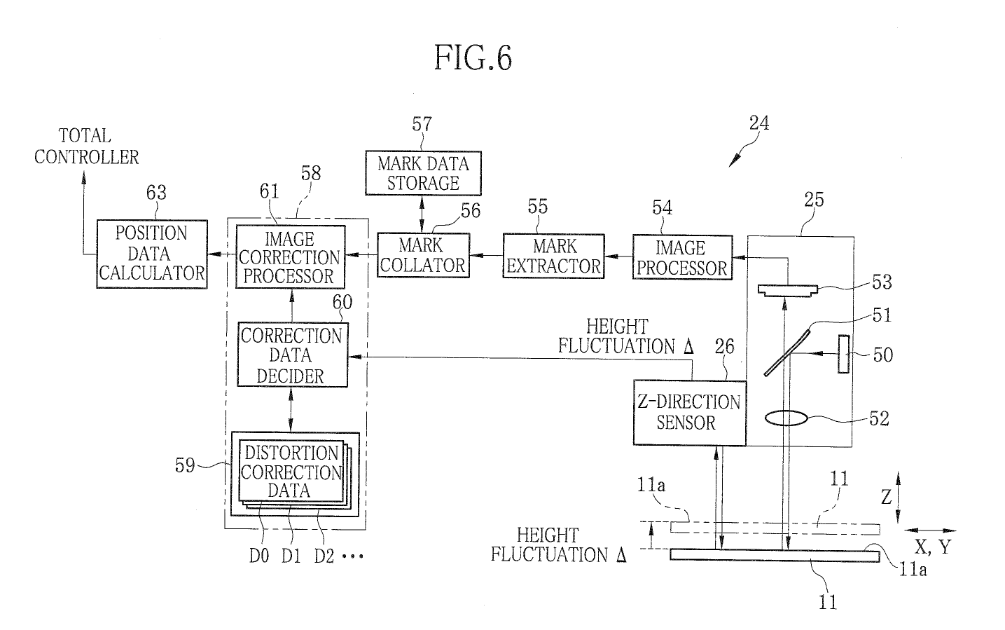

FIG. 6 shows an internal structure of the alignment unit 24. The cameras 25 are each constituted of a lighting section 50, a half mirror 51, a telecentric lens 52 and an imaging device 53. The lighting section 50 consists of LEDs or the like and emits white light or illumination light of a specific wavelength range toward the half mirror 51. The half mirror 51 reflects the illumination light from the lighting section 50 toward the telecentric lens 52. The telecentric lens 52 passes the incident illumination light through it to fall on the substrate 11 and also passes light reflected from the topside surface 11aof the substrate 11 through it. After passing through the telecentric lens 52, the reflected light from the topside surface 11afalls on the telecentric lens 52. The imaging device 53 is a two-dimensional image sensor, a CCD image sensor or the like, which converts incident light to electric image signals and outputs the electric image signals. The cameras 25 are each arranged so that an optical axis of the light falling on the imaging device 53 is substantially perpendicular to the topside surface 11aof the substrate 11, i.e. substantially parallel to the Z direction.

As described above, the Z-direction sensor 26 is affixed to the individual camera 25. The Z-direction sensor 26 projects a laser beam substantially vertically toward the topside surface 11aof the substrate 11. Making use of interference between the projected laser beam and a beam reflected from the topside surface 11a, the Z-direction sensor 26 measures a position of the topside surface 11awith respect to the Z direction. Concretely, the Z-direction sensor 26 measures a fluctuation amount Δ in the vertical position of the topside surface 11afrom an in-focus position or just-focus position of the camera 25. The Z-direction sensor 26 measures the fluctuation amounts Δ in areas around the respective reference marks M, and the measured fluctuation amounts Δ are sent to a distortion corrector 58, which will be described later.

The image signals output from the respective cameras 25 are fed to an image processor 54, to process the image signals into image data that correspond to the pattern formed on the substrate 11. The image data produced by the image processor 54 is fed to a mark extractor 55. The mark extractor 55 extracts those fragments of the image data, which contain the reference marks M, and sends them to a mark collator 56. The mark collator 56 checks the extracted image data with mark data that is previously stored in a mark data storage 57. The mark collator 56 sends such image data that coincide with the mark data, i.e. image data of the respective reference marks M, to the distortion corrector 58.

The distortion corrector 58 consists of a correction data storage 59, a correction data decider 60 and an image correction processor 61. The correction data storage 59 stores various sets of distortion correction data D0, D1, D2, . . . for correcting the image data to eliminate distortion of the image. The distortion of the image is caused by a variation in image-magnification that results from the fluctuation in height or position in the Z (vertical) direction of the substrate 11, i.e. a variation in distance of the substrate 11 from the camera 25. Specifically, the distortion correction data D0 is for correcting such a distortion that the image suffers even when the height fluctuation A is zero, namely the distortion induced by physical deformation of the camera 25, such as distortion of the optics or deformation of the imaging device. Other sets of distortion correction data D1, D2, D3 . . . correspond to predetermined fluctuation amounts Δ. For example, D1, D2, D3 and D4 correspond to fluctuation amounts Δ of +5 μm, +10 μm, −5 μm, and −20 μm, respectively.

The correction data decider 60 is fed with the height fluctuation amounts Δ measured by the Z-direction sensors 26, so the correction data decider 60 decides on the distortion correction data according to the height fluctuation amounts Δ by selecting it from among those stored in the correction data storage 59 or by calculation. Concretely, if any of the stored distortion correction data correspond to the input fluctuation amounts Δ, the correction data decider 60 selects the corresponding distortion correction data. If none of the stored distortion correction data correspond to the input fluctuation amounts Δ, the correction data decider 60 calculates such distortion correction data that correspond to the input fluctuation amounts Δ on the basis of the distortion correction data stored in the correction data storage 59, by interpolation, e.g. spline- or linear-interpolation.

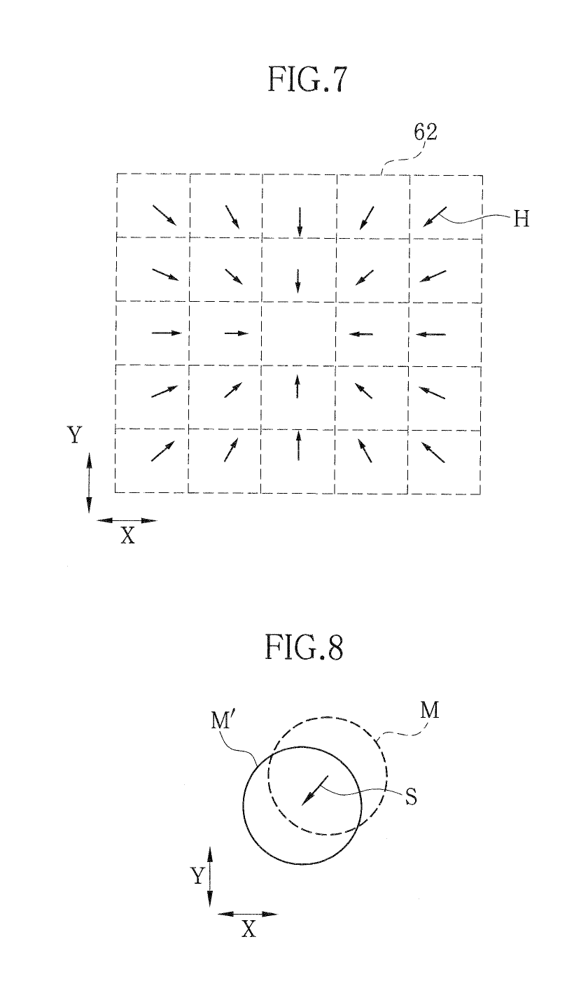

As shown in FIG. 7, the distortion correction data consists of vectors H for two-dimensional correction, each correction vector H representing a direction and an amount of correction for each individual one of all measurement points of an imaging field 62 of the camera 25. On the basis of the distortion correction data as decided by the correction data decider 60, the image correction processor 61 corrects distortions of the image data of the reference marks M, as sent from the mark collator 56, and sends the corrected image data of the reference marks M to a position data calculator 63.

As shown in FIG. 8, the position data calculator 63 compares a reference mark position M′ indicated by the input image data with an ideal or designed reference mark position M, to calculate an offset vector S. The offset vector S is calculated for each reference mark M, so the offset vectors S for the respective reference marks M are fed as position data of the substrate 11 to a total controller 70 of the digital exposure apparatus 10.

Referring to FIG. 9, the digital exposure apparatus 10 is provided with the total controller 70 that totally controls the digital exposure apparatus 10. The total controller 70 controls the stage driver 71 to drive and move the movable stage 12, and also controls the light source unit 19 and the image processing unit 21 to make exposures. The total controller 70 also controls the alignment unit 24 so that the position data of the substrate 11 as obtained through the alignment unit 24 is fed to a frame data producer 72 in the image processing unit 21, and controls the image processing unit 21 to execute a correction process on the frame data so as to correspond to the exposure area on the substrate 11.

The image processing unit 21 is provided with an image data storage 74 for storing rasterized image data that is output from an external image data output apparatus 73. The frame data producer 72 produces the frame data on the basis of the image data stored in the image data storage 74, and inputs the produced frame data to the DMD driver 39. Concretely, the frame data producer 72 produces the frame data on the basis of coordinate values of the respective exposure points in the respective exposure areas 40, which are determined by the positions of the respective micromirrors 33 of the respective DMDs 30 as well as the positions of the respective exposure heads 18. Moreover, the frame data producer 72 corrects the frame data on the basis of the position data of the substrate 11, which is detected by the alignment unit 24, so that the exposure points are formed at the same positions on the substrate 11 as they will be formed if the substrate 11 does not deviate from its ideal or designed position.

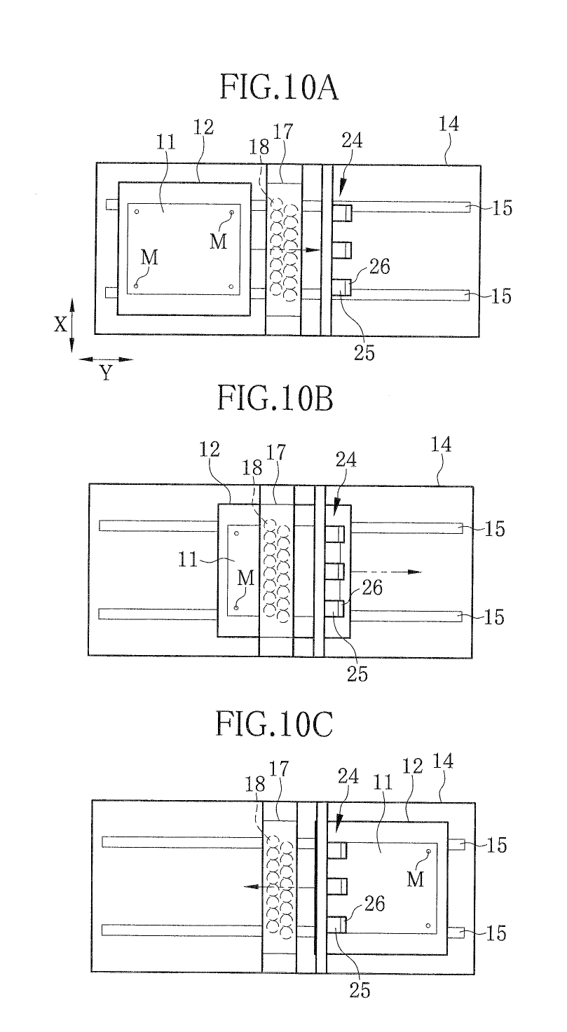

Now the exposure operation of the above-described digital exposure apparatus 10 will be explained with reference to FIGS. 10A, 10B and 10c, showing an operation sequence of the digital exposure apparatus 10. When the substrate 11 is placed on the movable stage 12, the stage 12 starts moving in a forward direction, that is to the right in FIG. 10A. During the forward movement of the movable stage 12, the total controller 70 monitors the position of the movable stage 12 through the Z-direction sensors 26 and not-shown X-direction and Y-direction sensors.

When a leading end of the movable stage 12 in the forward movement comes under the alignment unit 24, as shown in FIG. 10B, the cameras 25 starts imaging, and the Z-direction sensors 26 detect the height fluctuation amounts Δ of the topside surface lla of the substrate 11 during the imaging. When a trailing end of the movable stage 12 in the forward movement comes under the alignment unit 24, as shown in FIG. 10C, the cameras 25 stops imaging, and the image processor 54 produces image data. Using the image data from the image processor 54 and the height fluctuation amounts Δ from the Z-direction sensors 26, the alignment unit 24 detects the offset vectors S of the respective reference marks M accurately in the way as described above, and sends the offset vectors S as the position data of the substrate 11 to the total controller 70.

Thereafter the movable stage 12 begins to move in a backward direction, i.e. to the left in the drawings, and the exposure unit 17 exposes the substrate 11 as the substrate 11 passes under the exposure unit 17 during the backward movement of the movable stage 12. The exposure position of the substrate 11 by the exposure unit 17 is adjusted by correcting the timing of starting the exposure as well as the frame data (pattern data) on the basis of the position data of the substrate 11 that is measured by the alignment unit 24 in the way as described above.

As described so far, according to the present invention, the respective displacements of the reference marks M, which are caused by the fluctuation in height of the topside surface 11a of the substrate 11, are corrected without the need for adjusting the vertical position or height of the movable stage 12 while the position of the substrate 11 is being measured for alignment, that is, by the alignment unit 24 in the above embodiment. Therefore, the present invention achieves high-definition exposure and, at the same time, boosts the efficiency or throughput of processing. Because errors induced by the height fluctuation are corrected with high accuracy, the cameras 25 are not required to have highly accurate telecentricity.

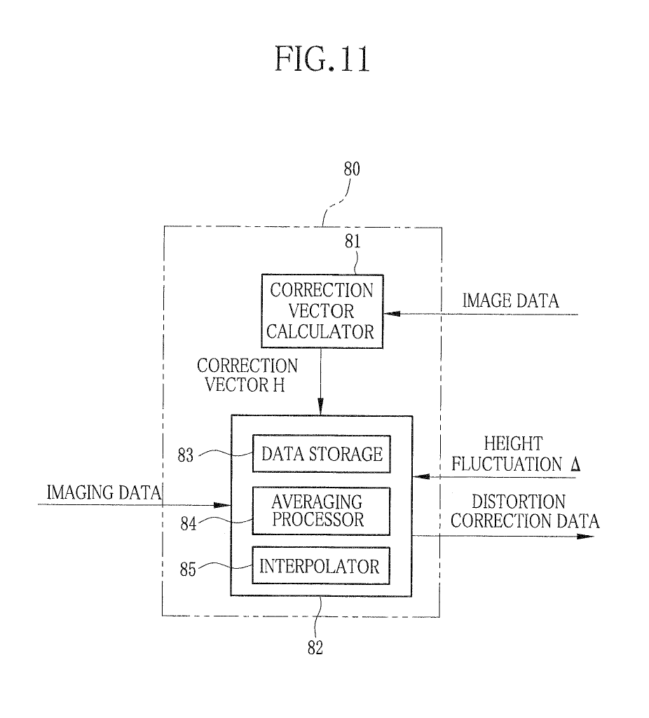

Beside the above-described exposure mode, the digital exposure apparatus 10 is provided with a distortion correction data production mode. In order to execute the distortion correction data production mode, the alignment unit 24 is further provided with a distortion correction data producer 80 as shown in FIG. 11. The distortion correction data producer 80 consists of a correction vector calculator 81 and an arithmetic operator 82.

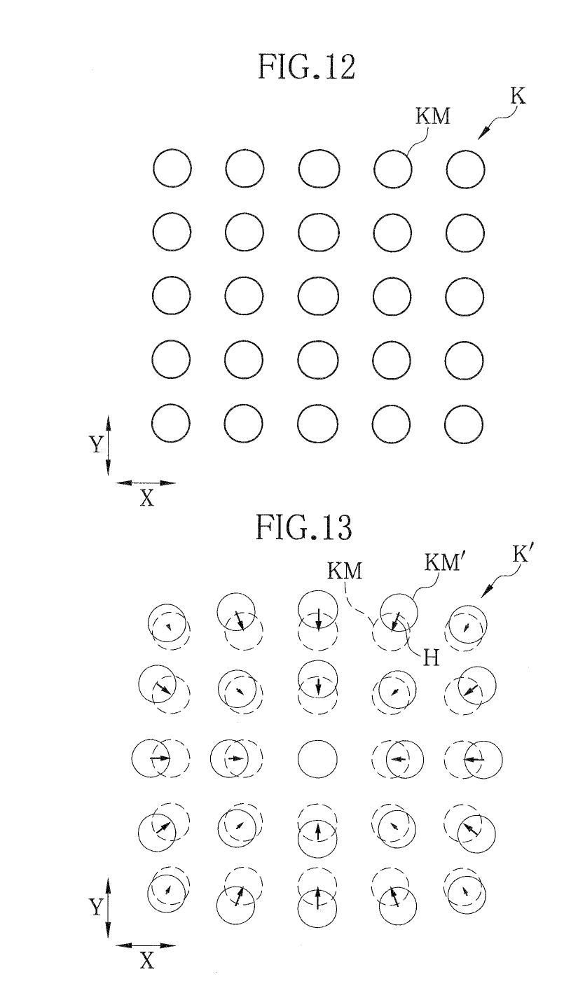

In the distortion correction data production mode, a calibrative substrate is used in place of the substrate 11. The calibrative substrate has a calibration pattern K formed on its topside surface. As shown in FIG. 12, the calibration pattern K consists of multiple of marks KM arranged in a matrix at sufficiently small intervals with respect to the imaging field 62 (FIG. 7) of the camera 25. The calibrative substrate is made of such a material as quartz that will not deform with time and thus keep the precision of calibration, whereas the calibration pattern K is formed by chromium plating.

Image data of the calibration pattern K as taken by the cameras 25 in the distortion correction data production mode is sent from the image processor 54 to the correction vector calculator 81 under the control of the total controller 70. The correction vector calculator 81 compares positions of respective marks KM′ of the imaged calibration pattern K′ with original positions of the marks KM, as shown in FIG. 13, to calculate correction vectors H on the basis of respective displacement amounts of the calibration marks KM′ from the original positions. The correction vectors calculated by the correction vector calculator 81 are fed to the arithmetic processor 82.

The arithmetic processor 82 is also fed with measurement values from the Z-direction sensors 26, which represent vertical positions of a topside surface of the calibrative substrate as height fluctuation amounts Δ from the just-focus position. Moreover, the arithmetic processor 82 is fed with imaging data that includes data of how many times the calibration pattern K was imaged, since the cameras 25 images the calibration pattern K several times for the sake of compensating for errors at individual imaging processes. The arithmetic processor 82 consists of a data storage 83, an averaging processor 84 and an interpolator 85. The data storage 83 stores the correction vectors H obtained by the several times of imaging. The averaging processor 84 averages the stored correction vectors H for each mark KM. The interpolator 85 interpolates the correction vectors H by spline- or linear interpolation with respect to the X and Y directions, to obtain the correction vector H at every point in the imaging field 62. The correction vectors H thus obtained are produced as distortion correction data and written in the above-mentioned correction data storage 59 in connection with the height fluctuation amounts Δ as measured by the Z-direction sensors 26.

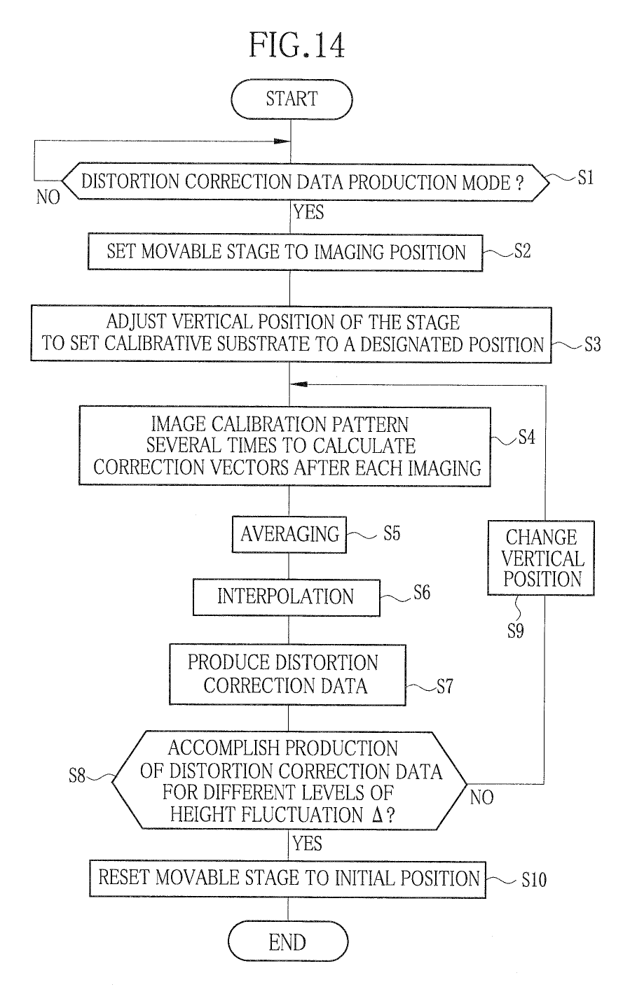

Next, the operation of the digital exposure apparatus 10 in the distortion correction data production mode will be described with reference to the flowchart of FIG. 14. First, the calibrative substrate is set on the movable stage 12, and when the distortion correction data production mode is set up by operating a not-shown operational member (“Yes” in step S1), the stage 12 is moved to a position where the calibration patterns K formed on the substrate are located in the respective imaging fields 62 of the cameras 25 (step S2). In this imaging position, the up-down mechanism 12c of the stage 12 is driven to adjust the position of the topside surface of the substrate in the Z direction, i.e. in the vertical direction (step S3). For example, the topside surface of the substrate is initially set at the just-focus position where the height fluctuation Δ=0.

In this position, the cameras 25 take image data from the calibration pattern K a designated number of times, while the correction vector calculator 81 calculates the correction vectors H from the image data taken at each imaging (step S4). Next, the arithmetic processor 82 averages the correction vectors H for each mark KM (step S5), and the interpolator 85 calculates and interpolates the correction vectors H allocated to all points of the imaging field 62 of the camera 25 (step S6), i.e. all pixels of the image taken by the individual camera 25. Thus, the distortion correction data for a particular height fluctuation amount Δ, initially Δ=0 in the present example, is produced and written in the correction data storage 59 in association with the particular fluctuation amount Δ.

Thereafter, the up-down mechanism 12c is driven again to change the vertical position of the topside surface of the calibrative substrate by a predetermined amount (step S9), to revise the height fluctuation amount Δ to be associated with the distortion correction data, and the steps S4 to S7 of the distortion correction data production process is executed to produce the distortion correction data for the revised height fluctuation amount Δ. The same procedure as above is repeated while changing the vertical position of the topside surface of the substrate. When the distortion correction data production process is accomplished for predetermined levels of height fluctuation Δ (“Yes” in step S8), the stage 12 is reset to an initial position (step S10), and the distortion correction data production mode is terminated.

As being provided with the distortion correction data production mode, the digital exposure apparatus 10 can correct time-induced errors in detection of the reference marks at appropriate times.

Although the reference marks are formed by embossing thin film in the above embodiment, the reference marks may be formed other ways such as printing. Also the locations of the reference marks are not limited to the above embodiment, but appropriately changeable. As the distortion correction data production mode is executed, the shape of the reference mark may also be appropriately changeable.

Although the reference marks are formed on the substrates in the above embodiment, the present invention is not limited to this embodiment, but is applicable to a case where reference marks are formed on a movable stage and are detected for positioning.

Moreover, the Z-direction sensor for detecting the vertical position of the topside surface of the substrate is not necessarily mounted to each camera, but it is possible to provide a single Z-direction sensor in relation to a plurality of cameras. The Z-direction sensor is not limited to the laser displacement meter, but may be another kind of length meter.

In the above embodiment, the lighting section for supplementing the imaging is mounted in the camera. But the lighting section is not limited to this embodiment, but is appropriately variable. It is possible to provide different kinds of lighting sections to be switchable between them. In that case, the distortion correction data is preferably produced for each kind of lighting section. The lighting section may emit light of variable wavelength. In that case, the distortion correction data is preferably produced with respect to each value of variable wavelength of light.

Furthermore, the imaging device and the lens are fixedly mounted in the camera in the illustrated embodiment, the imaging device and/or the lens may change its angle relative to the optical axis, like the prior art disclosed in the above-mentioned JPA 2007-10736. The imaging device may be a linear image sensor.

Although the digital exposure apparatus has been described as a preferred embodiment of the pattern-forming apparatus of the present invention, the present invention is not limited to the digital exposure apparatus that modulates light beams on the basis of pattern data and exposes a substrate to the modulated light beams to form a pattern on the substrate. The present invention may also be applicable to an ink-jet pattern-forming apparatus that ejects ink dots to form a pattern on the basis of pattern data.

Thus, the present invention is not to be limited to the above embodiment but, on the contrary, various modifications will be possible without departing from the scope of claims appended hereto.

What is claimed is:

1. A referential position measuring apparatus for measuring position of at least a reference mark that is formed on a stage or on a topside surface of a substrate placed on said stage, said referential position measuring apparatus comprising:
an imaging device located above said stage, for taking an image of said reference mark in a direction substantially perpendicular to the topside surface of said substrate;
a storage device storing different sets of distortion correction data corresponding to different levels of fluctuation of the topside surface of said substrate from a predetermined focal plane of said imaging device;
a measuring device for measuring a fluctuation amount of the topside surface of said substrate from the predetermined focal plane of said imaging device;
a deciding device for deciding an optimum set of distortion correction data on the basis of the measured fluctuation amount and the distortion correction data stored in said storage device;
a correction device for correcting distortion of the image of said reference mark as taken by said imaging device with the distortion correction data as decided by said deciding device; and
a position determining device for determining the position of said reference mark on the basis of said image of said reference mark after the distortion of said image is corrected by said correction device.

2. A referential position measuring apparatus as recited in claim 1, wherein said distortion correction data is directed to correct a distortion of the image induced by physical deformation of said imaging device and a change in image-magnification induced by the fluctuation of the topside surface of said substrate from the predetermined focal plane of said imaging device.

3. A referential position measuring apparatus as recited in claim 1, wherein said distortion correction data consists of two-dimensional correction vectors allocated to all pixels of said image taken by said imaging device.

4. A referential position measuring apparatus as recited in claim 1, wherein said imaging device comprises a telecentric optical system.

5. A referential position measuring apparatus as recited in claim 1, wherein said deciding device decides the optimum set of distortion correction data by selection from among the stored distortion correction data, or by calculation based on the stored distortion correction data.

6. A pattern-forming apparatus comprising:
a pattern-forming device driven in accordance with pattern data to form a pattern on a topside surface of a substrate as placed on a stage;
a transfer device for moving said stage or said pattern-forming device so that said substrate relatively moves past a pattern-forming field of said pattern-forming device;
a referential position measuring device for measuring position of at least a reference mark that is formed on said stage or on the topside surface of said substrate; and
an adjusting device for adjusting pattern-forming position of said pattern-forming device relative to the topside surface of said substrate on the basis of the position of said reference mark as measured by said referential position measuring device, wherein said referential position measuring device comprises:
an imaging device located above said stage, for taking an image of said reference mark in a direction substantially perpendicular to the topside surface of said substrate;
a storage device storing different sets of distortion correction data corresponding to different levels of fluctuation of the topside surface of said substrate from a predetermined focal plane of said imaging device;
a measuring device for measuring a fluctuation amount of the topside surface of said substrate from the predetermined focal plane of said imaging device;
a deciding device for deciding an optimum set of distortion correction data on the basis of the measured fluctuation amount and the distortion correction data stored in said storage device;
correction device for correcting distortion of the image of said reference mark as taken by said imaging device with the distortion correction data as decided by said deciding device; and
a position determining device for determining the position of said reference mark on the basis of said image of said reference mark after the distortion of said image is corrected by said correction device.

7. A pattern-forming apparatus as recited in claim 6, wherein said adjusting device adjusts said pattern-forming position by correcting said pattern data with reference to the position of the reference mark as measured by said referential position measuring device.

8. A pattern-forming apparatus as recited in claim 6, wherein said transfer device moves said stage along a linear track, whereas said referential position measuring device and said pattern-forming device are fixedly disposed above said linear track.

9. A pattern-forming apparatus as recited in claim 6, wherein the topside surface of said substrate is provided with a photosensitive material, and said pattern-forming device forms the pattern by exposing the topside surface to light beams.

10. A pattern-forming apparatus as recited in claim 9, wherein said pattern-forming device comprises a digital micromirror device that modulates the light beams in accordance with said pattern data.

11. A pattern-forming apparatus as recited in claim 10, wherein said pattern-forming device comprises an array of exposure heads, each of which is provided with said digital micromirror device, said exposure heads being arranged in rows orthogonally to a direction of the relative movement of said substrate to said pattern-forming device.

12. A referential position measuring method for measuring position of at least a reference mark that is formed on a stage or on a topside surface of a substrate placed on said stage, said referential position measuring method comprising steps of:
storing different sets of distortion correction data corresponding to different levels of fluctuation of the topside surface of said substrate from a predetermined focal plane of an imaging device whose optical axis is substantially perpendicular to the topside surface of said substrate;
taking an image of said reference mark through said imaging device;
measuring a fluctuation amount of the topside surface of said substrate from said predetermined focal plane;
deciding an optimum set of distortion correction data on the basis of the measured fluctuation amount and the stored distortion correction data;
correcting distortion of the image of said reference mark with the decided distortion correction data; and
determining the position of said reference mark on the basis of the image of said reference mark after the distortion is corrected.

13. A referential position measuring method as claimed in claim 12, wherein the different sets of distortion correction data corresponding to different levels of fluctuation from the predetermined focal plane are previously calculated on the basis of image data obtained through said imaging device from a calibrative substrate that has a calibration pattern formed on its topside surface, while changing position of the topside surface of said calibrative substrate gradually from said predetermined focal plane.
